(19) United States
(12) Patent Application Publication
(10) Pub. No.: US 2013/0273373 A1
(43) Pub. Date: Oct. 17, 2013

(54) OVERCOAT COMPOSITION FOR SEAMED INTERMEDIATE TRANSFER BELT

(71) Applicants: Robert C. U. Yu, Webster, NY (US); Edward F. Grabowski, Webster, NY (US); Francisco Lopez, Philadelphia, PA (US)

(72) Inventors: Robert C. U. Yu, Webster, NY (US); Edward F. Grabowski, Webster, NY (US); Francisco Lopez, Philadelphia, PA (US)

(73) Assignee: XEROX CORPORATION, Norwalk, CT (US)

(21) Appl. No.: 13/446,395

(22) Filed: Apr. 13, 2012

(51) Int. Cl. B32B 9/04; G03G 15/01

(52) U.S. Cl. 428/411.1; 399/302

(57) ABSTRACT

The presently disclosed embodiments relate generally to an image forming apparatus comprising an overcoat layer disposed directly over in contact with the top circumferential surface of a seamed intermediate transfer belt, and methods for making the same. The overcoat layer, comprising a film forming A-B diblock copolymer and conductive particles dispersion, not only renders the seam area physical/mechanical/electrical continuity for achieving absolute belt surface imageability to function like a seamless intermediate transfer belt, it also provides increased mechanical strength to resist fatigue-bend cracking under normal dynamic intermediate transfer belt machine cycling conditions in the field. The overcoat of this disclosure thus helps to reduce wear and extend service life of the belt.

### BACKGROUND

The presently disclosed embodiments relate generally to layers that are useful in imaging apparatus members and components, for use in electrophotographic, including digital printing, apparatuses. More particularly, the embodiments pertain to electrophotographic printing apparatus utilizing an improved toner image transfer member comprising a composition used to form an image transferring member component; namely, the inclusion of an added-on innovative over coating layer directly onto the entire surface of a seamed intermediate transfer belt. The composition of the added overcoat layer, comprising of a high molecular weight film forming polycarbonate-phthalic acid diblock copolymer, provide the resulting intermediate transfer belt with numerous beneficial properties, such as:

(1) superior mechanical flexibility, scratch/wear resistance, and fatigue bend induced belt cracking suppression to extend the service life of the over-coated seamed intermediate transfer belt in the field; and
(2) the overcoat covers the seam and the top circumferential belt surface to give physical/electrical continuity and which provides a seamed intermediate transfer belt an entire imageable belt surface, so that it functions like a seamless belt.

In electrophotography or electrophotographic printing, the charge retentive surface, typically known as a photoreceptor, is electrostatically charged, and then exposed to a light pattern of an original image to selectively discharge the surface in accordance therewith. The resulting pattern of charged and discharged areas on the photoreceptor form an electrostatic charge pattern, known as a latent image, conforming to the original image. The latent image is developed by contacting it with a finely divided electrostatically attractable powder known as toner. Toner is held on the image areas by the electrostatic charge on the photoreceptor surface. Thus, a toner image is produced in conformity with a light image of the original being reproduced or printed. The toner image formed on the photoreceptor surface may then be transferred to a receiving substrate or support member (e.g., paper) directly or first through the use of an intermediate transfer member, and the image affixed thereto to form a permanent record of the image to be reproduced or printed followed by transferring it to the receiving paper for fussing into copy printout. Subsequent to development, excess or residue toner left on the charge retentive surface is cleaned from the surface. The process is useful for light lens copying from an original or printing electronically generated or stored originals such as with a raster output scanner (ROS), where a charged surface may be imagewise discharged in a variety of ways.

The foregoing generally describes black and white electrophotographic printing machines. Electrophotographic printing can also produce color images by repeating the above process for each color of toner that is used to make the color image. For example, the photoreceptive surface may be exposed to a light image that represents a first color, say black. The resultant electrostatic latent image can then be developed with black toner particles to produce a black toner layer that is subsequently transferred onto a receiving substrate. The process can then be repeated or a second color, say yellow, then for a third color, say magenta, and finally for a fourth color, say cyan. When the toner layers are placed in superimposed registration the desired composite color toner image is formed and fused on the receiving substrate.

The color printing process described above superimposes the color toner layers directly onto a substrate. Other electrophotographic printing systems use intermediate transfer belts. In such systems successive toner layers are electrostatically transferred in superimposed registration from the photoreceptor onto an intermediate transfer belt. Only after the composite toner image is formed on the intermediate transfer belt is that image transferred and fused onto the substrate. Indeed, some electrophotographic printing systems use multiple intermediate transfer belts, transferring toner to and from belts as required to fulfill the requirements of the machine's overall architecture.

In operation, an intermediate transfer belt is brought into contact with a toner image-bearing member such as a photoreceptor belt. In the contact zone an electrostatic field generating device such as a corotron, a bias transfer roller, a bias blade, or the like creates electrostatic fields that transfer toner onto the intermediate transfer belt. Subsequently, the intermediate transfer belt is brought into contact with a receiver. A similar electrostatic field generating device then transfers toner from the intermediate transfer belt to the receiver. Depending on the system, a receiver can be another intermediate transfer member or a substrate onto which the toner will eventually be fixed. In either case the control of the electrostatic fields in and near the transfer zone is a significant factor in toner transfer.

Intermediate transfer belts often take the form of seamed belts fabricated by fastening two ends of a web material together, such as by welding, sewing, wiring, stapling, or gluing. Belts, sheets, films and the like are important to the xerographic process. Belt function is often adversedly affected by the presence of a seam in the belt. For example, belts formed according to known butting or overlapping techniques provide a bump or other discontinuity in the belt surface leading to a height differential between adjacent portions of the belt, for example, of 0.010 inches or more depending on the belt thickness. This increased height differential leads to performance failure in many applications. When overlapping the opposite ends of a rectangular cut sheet and ultrasonically welded into a seamed intermediate transfer belt, the seam of the flexible intermediate transfer belt may occasionally contain undesirable high protrusions such as peaks, ridges, spikes, and mounds. These seam protrusions present problems during image cycling of the belt machine because they interact with cleaning blades to cause blade wear and tear, which ultimately affect cleaning blade efficiency and service life.

Another major disadvantage of having a seam in the flexible intermediate transfer belt is that the seam is a non imageable area due to physical/morphological discontinuity and electrical variation from the bulk of the belt, so it causes print defects in copy image printout. To avoid the above problems, seamless intermediate transfer belts are preferred instead, because the entire belt surface of the seamless intermediate transfer belt is imageable area without the complications caused by the seamed region of seamed belts. However, these seamless intermediate transfer belts do require manufacturing processes that are more involved and/or expensive than the similar seamed intermediate transfer belt counterparts. This is particularly true when the seamless intermediate transfer belt is a long belt.

To overcome all the above mentioned problems, over-coating the top circumferential surface of a seamed intermediate transfer belt is therefore preferred. As a consequence of the inclusion of an added-on overcoat layer, the top circumferential surface of the seamed intermediate transfer belt has been converted into imageable area to thereby eliminate the complications and problems caused by the seamed region of a seamed belt. Furthermore, the addition of the overcoat layer does also provide desirable mechanical flexibility, scratch/wear resistance, and fatigue bend induced belt cracking suppression to extend the service life of the overcoated intermediate transfer belt functioned in the field.

Due to the usage demands on the imaging member systems, the component parts are subject to significant wear which negatively impacts performance and service life. Thus, there is a constant need for improving such systems and parts, such as intermediate transfer belt having an entirely effective imageable surface in particular, to provide good toner image transferring performance and mechanically robust function as well to extend service life in the field. Particularly, there is a need for an efficient method of providing an intermediate transfer belt having improved properties and low manufacturing cost. To achieve this very objective, the present effort is focused on the preparation of an over-coat design of this disclosure for seamed intermediate transfer belt application.

Prior conventional intermediate transfer belts are disclosed in U.S. Pat. Nos. 7,130,569, 6,101,360 and 6,044,243, which are hereby incorporated by reference in their entireties. The term “photoreceptor” or “photoconductor” is generally used interchangeably with the terms “imaging member.” The term “electrophotographic” includes “electrophotographic” and “xerographic.” The terms “charge transport molecule” are generally used interchangeably with the terms “hole transport molecule.”

### SUMMARY

According to the embodiments illustrated herein, there is provided a novel composition for use in print head assemblies.

In particular, the present embodiments provide an overcoated seamed intermediate transfer belt comprising: a seamed intermediate transfer belt; and an overcoat layer comprising a polycarbonate disposed on the seamed intermediate transfer belt, wherein the polycarbonate is an A-B diblock copolymer comprising a bisphenol A polycarbonate segmental block (A) and a phthalic acid containing segmental block (B) terminal selected from the group consisting of Formula (I) and Formula (II) below:

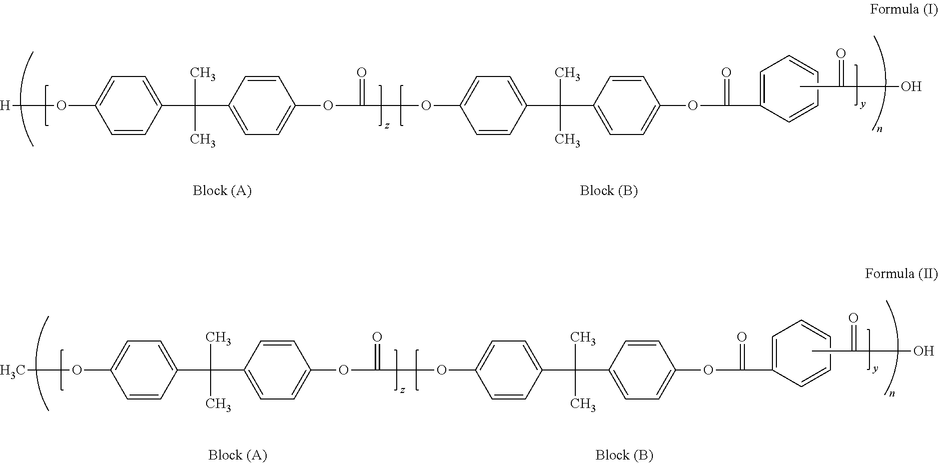

wherein z represents the number of bisphenol A repeating units in segmental block (A) of from about 9 to about 18, y is number of repeating phthalic acid segmental block (B) of from about 1 to about 2, and n is the degree of polymerization between about 20 and about 90 for the copolymer having a weight average molecular weight between about 100,000 and about 250,000 and mixtures thereof.

In further embodiments, there is provided an image forming apparatus comprising: an imaging member for forming a toner image; and an overcoated seamed intermediate transfer belt for transferring the toner image formed on the imaging member to a receiving medium, the overcoated seamed intermediate transfer belt comprising a seamed intermediate transfer belt, and an overcoat layer comprising a polycarbonate disposed on the seamed intermediate transfer belt, wherein the overcoat layer comprises a dispersion of carbon black particles in an A-B diblock copolymer comprising a bisphenol A polycarbonate segmental block (A) and a phthalic acid containing segmental block (B) terminal selected from the group consisting of Formula (I) and Formula (II) below:

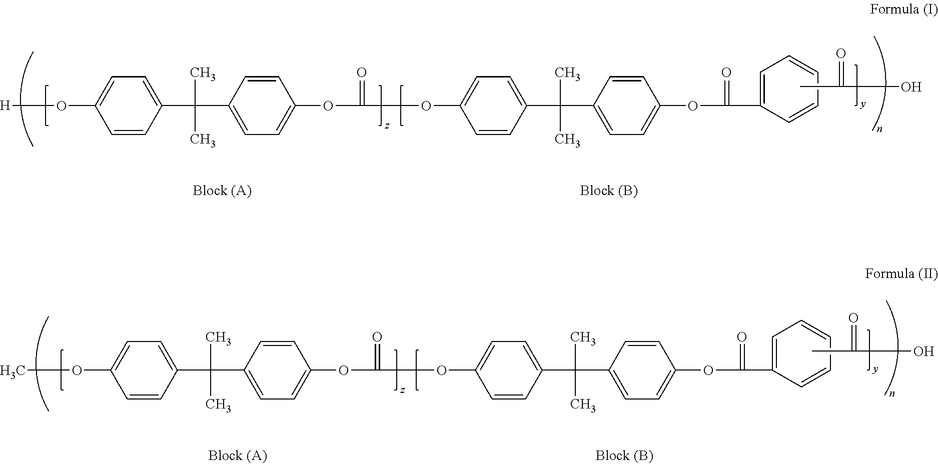

wherein z represents the number of bisphenol A repeating units in segmental block (A) of from about 9 to about 18, y is number of repeating phthalic acid segmental block (B) of from about 1 to about 2, and n is the degree of polymerization between about 20 and about 90 for the copolymer having a weight average molecular weight between about 100,000 and about 250,000 and mixtures thereof.

In yet other embodiments, there is provided an image forming apparatus comprising: an imaging member for forming a toner image; and an overcoated seamed intermediate transfer belt for transferring the toner image formed on the imaging member to a receiving medium, the overcoated seamed intermediate transfer belt comprising a seamed intermediate transfer belt, and an overcoat layer comprising a polycarbonate disposed on the seamed intermediate transfer belt, wherein the polycarbonate is an A-B diblock copolymer comprising a bisphenol A polycarbonate segment block (A) and a phthalic acid containing segment block (B) terminal selected from the group consisting of Formula (I) and Formula (II) below:

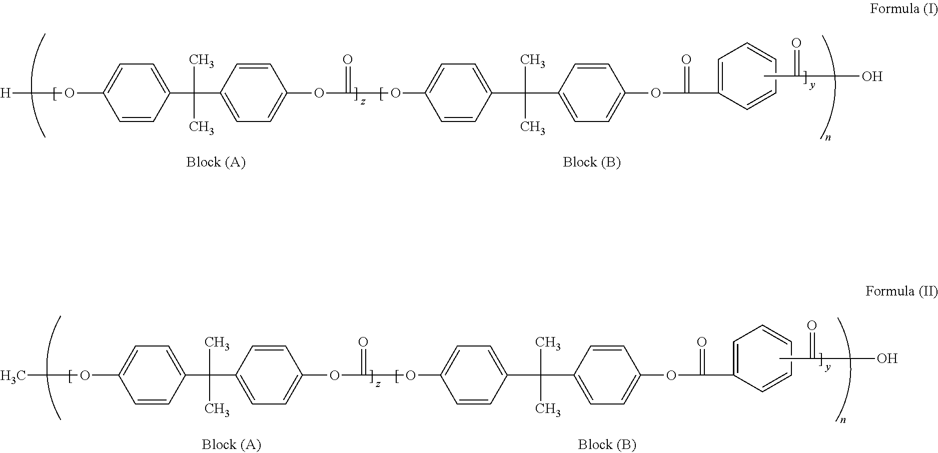

wherein z represents the number of bisphenol A repeating units in segmental block (A) of from about 9 to about 18, y is number of repeating phthalic acid segmental block (B) of from about 1 to about 2, and n is the degree of polymerization between about 20 and about 90 for the copolymer having a weight average molecular weight between about 100,000 and about 250,000 and mixtures thereof.

### BRIEF DESCRIPTION OF THE DRAWINGS

For a better understanding, reference may be made to the accompanying figures.

FIG. 1 is a schematic view showing one example of an image forming apparatus according to the present embodiments;

FIG. 2 is a schematic view showing a portion of an image forming apparatus according to the present embodiments; and

FIG. 3 shows a full belt width cross-sectional view of an overcoated intermediate transfer belt prepared according to the formulation of present embodiments.

### DETAILED DESCRIPTION

In the following description, reference is made to the accompanying drawings, which form a part hereof and which illustrate several embodiments. It is understood that other embodiments may be used and structural and operational changes may be made without departure from the scope of the present disclosure.

To overcome the limitations associated with imaging member systems and component parts, as discussed above, the disclosed embodiments are directed generally to electrophotographic imaging printing apparatus utilizing an improved toner image transfer member, prepared to have the inclusion of an overcoating layer applied directly over the top circumferential surface of a seamed intermediate transfer belt. The overcoating layer is prepared to comprise a novel material formulation according to the description of present disclosure such that it covers the seam and the entire top surface of a seamed intermediate transfer belt to effect seam area physical/mechanical/electrical continuity for achieving total belt surface area imageability to function like a seamless belt. The novel overcoat design is formulated by the use of a high molecular weight film forming A-B diblock copolymer that renders mechanical function improvement; good belt flexibility; fatigue bending induced cracking extension; enhancement of scratch/wear resistance; and very importantly, entire belt surface area imageability. In embodiments, the overcoat applied directly onto the top circumferential surface of the seamed intermediate transfer belt does also have carbon black particles dispersion inclusion in its material matrix to effect electrical conductivity. The formulation of an overcoat, utilizing the novel high molecular weight A-B diblock copolymer, according to the disclosure of the present embodiments, for seamed intermediate transfer belt application not only has eliminated the common short comings and problems associated with the seam discontinuity of a seamed intermediate transfer belt, it does also offer a more easily manufactured and low cost production approach than the current preparation process of seamless intermediate transfer belts. For example, since typical formulation of current mainline polyimide material used for seamless intermediate transfer belts fabrication does involve a cross-linking reaction at high temperature of more than 350° C. during curing and long cycle time of many hours to complete, so it is a time and energy consuming process too costly for practical manufacturing consideration.

In the embodiments of present disclosure, a film forming high molecular weight (Mw) and high Tg A-B diblock copolymer is selected for overcoat formulation. The diblock copolymer can conveniently be dissolved in a common organic solvent to give a coating solution of proper viscosity. The prepared coating solution is solution cast onto to cover the top circumferential surface of a seamed intermediate belt and then dried the wet coating at a temperature of at least 10° C. above the boiling point of the solvent to give a resulting overcoated seamed intermediate transfer belt of this disclosure. The overcoat as prepared has excellent thickness uniformity and strong adhesion bonding to (or non separable from) the intermediate transfer belt. In further embodiments, the formulation of the overcoat layer for seamed intermediate belt application may also include carbon black particles dispersion in its material matrix such that the resulting overcoated belt thus obtained gives good electrical resistivity, mechanical strength enhancement to resist scratch/wear failure, thermal stability, and extended dynamic fatigue cycling life over machine belt support module without premature onset of cracking development as it functions in the field.

The exemplary embodiments of this disclosure are described below with reference to the drawings. The specific terms are used in the following description for clarity, selected for illustration in the drawings and not to define or limit the scope of the disclosure. The same reference numerals are used to identify the same structure in different figures unless specified otherwise. The structures in the figures are not drawn according to their relative proportions and the drawings should not be interpreted as limiting the disclosure in size, relative size, or location.

The image forming apparatus of the present embodiments is not particularly limited insofar as it belongs to an intermediate transfer body format, that is, an image forming apparatus having a structure provided with at least a first transfer means for primarily transferring a toner image formed on an image bearing body onto an intermediate transfer belt, and a second transfer means for secondarily transferring a toner image transferred on the intermediate transfer belt, onto a transfer body. Examples of the image forming apparatus of the present embodiments include a normal monocolor image forming apparatus in which only single color toners are accommodated in a developing device, a color image forming apparatus in which successive primary transfer of a toner image held on an image bearing body onto an intermediate transfer body is repeated, and a tandem-type color image forming apparatus in which a plurality of image bearing bodies provided with developing equipment for every color are arranged on an intermediate transfer body in series.

In addition, according to known methods, the image forming apparatus of the present embodiments may be optionally provided with an image bearing body, an electrification means for electrifying an image bearing body surface, an exposing means for exposing an image bearing body surface to the light to form an electrostatic latent image, a developing means for developing a latent image formed on an image bearing body surface using a developer to form a toner image, a means for fixing a toner image on a transfer body, a cleaning means for removing a toner and refuse attached to an image bearing body, and a discharging means for removing an electrostatic latent image remaining on an image bearing body surface, if necessary.

A specific embodiment of a tandem-type color image forming apparatus will be explained below using the drawings.

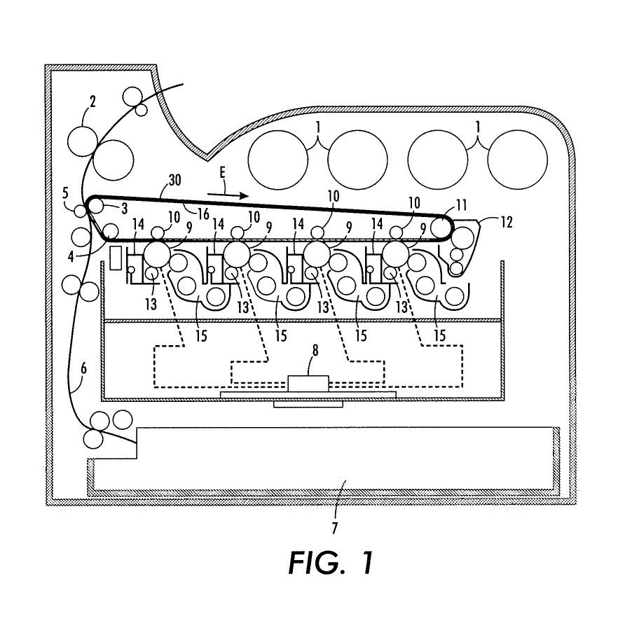

FIG. 1 is a schematic view showing one example of the image forming apparatus of the present embodiments. The image forming apparatus showed in FIG. 1 contains, as principal constituent members, four toner cartridges 1, one pair of fixing rolls 2, a back-up roll 3, a tension roll 4, a secondary transfer roll (secondary transfer means) 5, a paper path 6, a paper tray 7, a laser-generating device 8, four photoreceptors (image members) 9, four primary transfer rolls (primary transfer means) 10, a driving roll 11, a transfer cleaner 12, four electrification rolls 13, a photoreceptor cleaner 14, a developing device 15, and an overcoated intermediate transfer belt consisting of a disclosed overcoat 30 and a seamed (seam not shown) intermediate transfer belt 16. In the image forming apparatus illustrated in FIG. 1, an overcoated seamed intermediate transfer belt of the present embodiments is used to transfer toner image from the image bearing body (photoreceptor) surface, function as a means for overlaying toner images, and a means as well for subsequently delivering the overlaying toner images to a receiving member such as paper to give print out copy.

Next, construction of an image forming apparatus as shown in FIG. 1 will be explained in stages. First, an electrification roll 13, a developing device 15, a primary transfer roll 10 disposed via an overcoated intermediate transfer belt, and a photoreceptor cleaner 14 are arranged counterclockwisely around a photoreceptor 9, and one set of these members form a developing unit corresponding to one color. In addition, each of these developing units is provided with a toner cartridge 1 for replenishing developer to each developing device 15, and a laser-generating device 8 which can irradiate laser light to a surface of the photoreceptor 9 between the electrifying roll 13 and the developing device 15 according to image information is provided relative to the photoreceptor 9 of each developing unit.

Four developing units corresponding to four colors (e.g. cyan, magenta, yellow, and black) are arranged in series in an approximately horizontal direction in an image forming apparatus, and an overcoated seamed intermediate transfer belt 16 (seam not shown) having an overcoat 30 of this disclosure is provided so as to pass through a nip part between the photoreceptor 9 and the primary transfer roll 10 of each of the four developing units. The intermediate transfer belt 16 is stretched by a back-up roll 3, a tension roll 4, and a driving roll 11 which are provided in this order counterclockwisely on its inner circumferential side. Four primary transfer rolls are situated between the back-up roll 3 and the tension roll 4. A transfer cleaner 12, for cleaning an external circumferential surface of the overcoat 30, is provided so as to contact with the driving roll 11 under pressure, via the overcoated intermediate transfer belt, on an opposite side of the driving roll 11.

In addition, a secondary transfer roll 5 for transferring a toner image formed on the external circumferential surface of the intermediate transfer belt 16 onto a surface of a recording paper conveyed from a paper tray 7 via a paper path 6 is provided so as to contact with the back-up roll 3 under pressure, on an opposite side of the back-up roll 3 via the intermediate transfer belt 16. On the external circumferential surface of the overcoated seamed intermediate transfer belt between the back-up roll 3 and the driving roll 11, a discharging roll (not shown) for discharging the external circumferential surface is provided.

In addition, a paper tray 7 for stocking recording paper is provided at the bottom of the image forming apparatus, and paper can be supplied so as to pass through a pressure-contacting part between the back-up roll 3 and the secondary transfer roll 5 constituting a secondary transfer portion from the paper tray 7 via a paper path 6. A recording paper which has passed through this pressure-contacting part can be conveyed by a conveying means (not shown) so as to pass through a pressure-contacting part of a pair of fixing rolls 2 and, finally, can be ejected outside of the image forming apparatus.

Next, an image forming method using the image forming apparatus of FIG. 1 will be explained. A toner image is formed at every developing unit, and the surfaces of the photoreceptors 9 rotating counter-clockwise are uniformly electrified with electrifying rolls 13, after which latent images are formed on the surfaces of the electrified photoreceptors 9 with a laser-generating device 8 (exposing device), and then the latent images are developed with a developer supplied from the developing devices 15 to form toner images, and the toner images brought to a pressure-contacting part between the primary transfer rolls 10 and the photoreceptors 9 are transferred onto the external circumferential surface of the intermediate transfer belt 16 rotating in the direction of arrow E. Toner and refuse adhered to the surface of the photoreceptors 9 after transfer of the toner images are cleaned with photoreceptor cleaners 14, ready for formation of the next toner image.

Toner images of each color developed at every developing unit are successively superimposed on the external circumferential surface of the overcoated seamed intermediate transfer belt so as to correspond to image information, and are delivered thus to the secondary transfer portion where they are transferred onto a surface of a recording (or receiving) paper conveyed from paper tray 7 via paper path 6, with the secondary transfer roll 5. A recording paper onto which a toner image has been transferred is further fixed by heating under pressure upon passing through a pressure-contacting part of the pair of fixing rolls 2 constituting a fixing portion and, after formation of an image on a recording medium surface, it is discharged outside the image forming apparatus.

An overcoated seamed intermediate transfer belt of present disclosure has passed through a secondary transfer portion proceeds further in the direction of arrow E, the external circumferential surface thereof is electricity-removed with a discharging roll (not shown), and the external circumferential surface is cleaned with a transfer cleaner 12, ready for transfer of a next toner image.

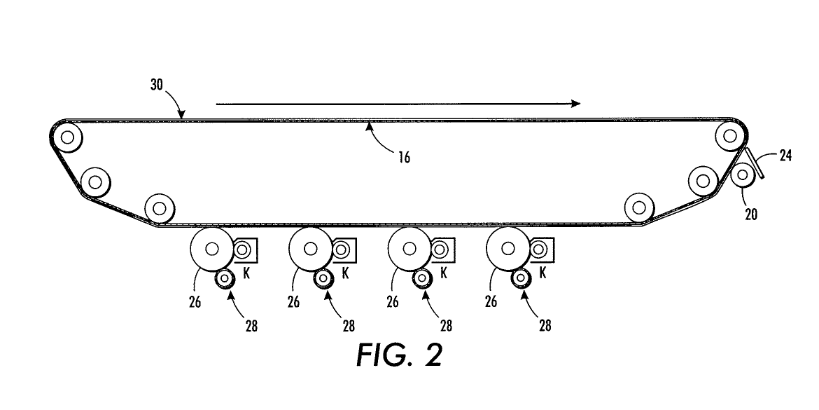

Shown in FIG. 2 is an exemplary embodiment of a portion of an image forming apparatus according to the present embodiments. As shown, a delivery member 20 is placed in contact with the overcoated seamed intermediate transfer belt (which as shown to have an overcoat 30 on a seamed intermediate transfer belt 16) in the post-cleaning position after the intermediate transfer belt cleaning unit 24, such as a blade. The cleaning unit for the overcoated seamed intermediate transfer belt is disposed in contact with the surface of overcoat 30 of the belt for cleaning off residual toner and debris from the surface. The single delivery member 20 can supply a release material or other similar material to the surface of overcoat 30 of the seamed intermediate transfer belt 16, which in turn delivers the same to the surface of each of the photoreceptors 26 to further help clean the transfer belt or reduce friction to the surface. In alternative embodiments, there can be provided a separate delivery member for each of the photoreceptors 26 in the CRU 28, rather than only the single delivery member 20.

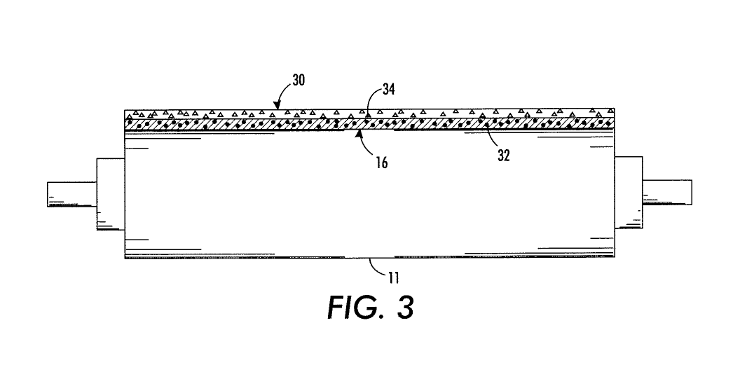

According to the illustration in FIG. 3, there is provided the full belt width cross-sectional view of an overcoated seamed intermediate transfer belt of this disclosure. The intermediate transfer belt 16 takes the form of a seamed belt fabricated by fastening the two overlapping opposite ends of a rectangular cut sheet and ultrasonically welded into the seamed intermediate transfer belt 16. The resulting seam contains undesirable protrusions such as peaks, ridges, spikes, mounds, and a seam region height, which is addressed by the overcoat layer 30.

The overcoat layer 30 over the outer circumferential surface of a seamed (seam not shown) intermediate transfer belt 16 is made from the novel formulation comprising the A-B diblock copolymer and may further include conductive carbon black particles 34 dispersed therein to provide desirable electrical conductivity, increased mechanical function to resist surface scratch/wear, and early onset of fatigue-bend induced belt surface cracking under normal dynamic intermediate transfer belt machine cycling conditions in the field; therefore, the addition of an overcoat 30 of this disclosure to the seamed intermediate transfer belt 16 thus helps to reduce propensity of pre-mature belt failure and extend service life of the belt. Other added benefits provided by the overcoat include desirable properties such as good resistivity, mechanical enhancement, reasonable coefficient of thermal expansion (less than 6×10⁻⁵/° C.)., and effective dynamic belt cycling life extension. The overcoat 30 formulation is prepared by first dissolving the A-B diblock copolymer in a preferred organic solvent to formed a coating solution, then solution coated over and the entire circumferential top surface of the flexible seamed intermediate transfer belt 16, and followed by subsequently dried at elevate temperature of at least 10° C. higher than the boiling point of the solvent. The resulting dried over coating layer 30 of this disclosure thus obtained has strong and non separable bonding to the seamed intermediate belt 16 and give uniform thickness as well to provide a homogeneous imageability belt surface area which functions like a seamless belt.

In a first embodiment, the overcoat 30 applied onto the seamed intermediate transfer belt 16 is comprised of a polycarbonate which is a film forming high molecular weight A-B diblock copolymer. In particular, the polycarbonate is an A-B diblock copolymer comprising a bisphenol A polycarbonate segment block (A) and a phthalic acid containing segment block (B) terminal capable of providing protection against amine species contaminants, selected from the group consisting of Formula (I) and Formula (II) shown below:

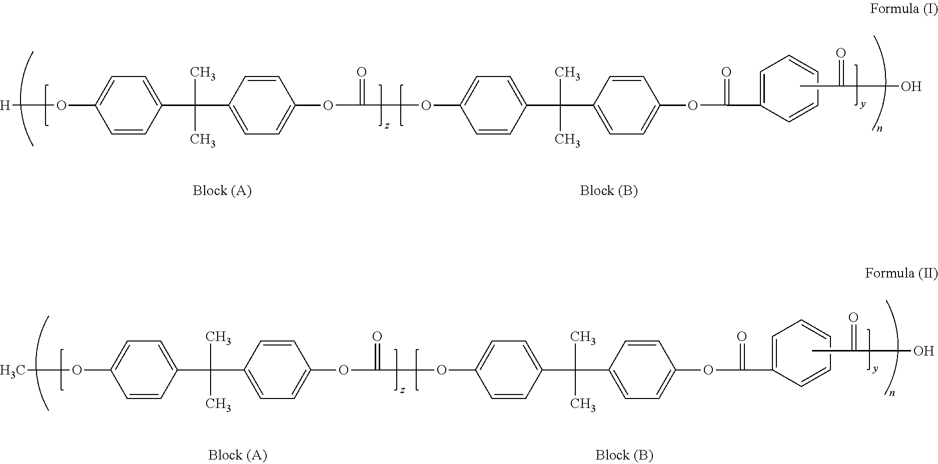

wherein z represents the number of bisphenol A repeating units in block A of from about 9 to about 18, y is number of repeating phthalic acid block B of from about 1 to about 2, and n is the degree of polymerization between about 20 and about 90 for the copolymer having a weight average molecular weight between about 100,000 and about 250,000, or from about 40 to about 70, in which the copolymer may have a weight average molecular weight between about 130,000 and about 200,000, and mixtures thereof. The phthalic acid in segment block (B) of the A-B diblock copolymer may either be a terephthalic acid or isophthalic acid represented respectively by the following structures:

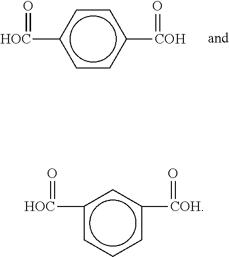

The specific A-B diblock copolymer chosen to meet the overcoat formulation requirement is LEXAN HLX polymer available from Sabic Innovative Plastics (Pittsfield, Mass.). The LEXAN HLX (as described in the above Formulas (I) and (II)) is a bisphenol A polycarbonate/phthalic acid film forming copolymer. The novel film forming A-B diblock copolymer, being a polycarbonate, is derived/modified from bisphenol A polycarbonate structure by the inclusion of small fraction of phthalic acid into the polymer backbone such that the resulting copolymer contains about 90 mole percent of a bisphenol A segment block (A) linearly linking to about 10 mole percent of a segmental block (B) of phthalic acid terminal in the A-B diblock copolymer chain. The copolymer as obtained has an average weight molecular of about 175,000.

In a second embodiment, the film forming A-B diblock copolymer used comprises the same bisphenol A polycarbonate poly(4,4′-isopropylidene diphenyl carbonate) block (A) and a phthalic acid containing terminal segmental block (B), but with the difference that the end terminal of the bisphenol A polycarbonate segment block (A) is terminated with a methy, —CH₃, group. Thus, in this A-B diblock copolymer, the molecular structure becomes Formula (II), with z, y and n being the same as defined in the above Formula (I):

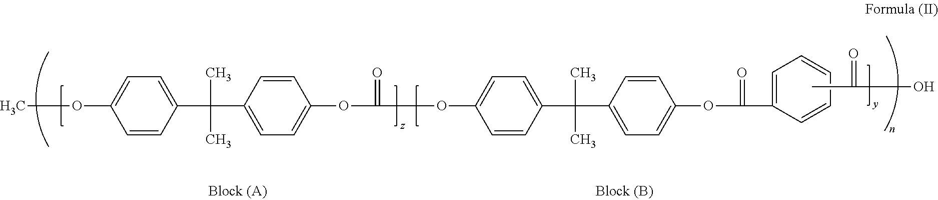

In these embodiments, the overcoat for seamed intermediate transfer belt application is formulated and prepared according to the material formulation and process of the present disclosure. The overcoated seamed seamless intermediate transfer belt of the present embodiments has demonstrated to be very mechanically robust which provides surface scratch/wear resistance and prevents early onset of dynamic fatigued bend belt cracking development as well to achieve its functional life extension.

In a third embodiment, the overcoated seamed intermediate transfer belt of present disclosure may further be formulated in the same manners described in all the preceding embodiments, except that they are prepared to comprise of variants of film forming thermoplastic materials derived by replacement of the bisphenol A polycarbonate segmental block (A) of the A-B diblock copolymer of Formulas (I) and (II) by alternate polycarbonate. The exemplary block (A) alternate polycarbonates in the A-B diblock copolymer variants are the following:

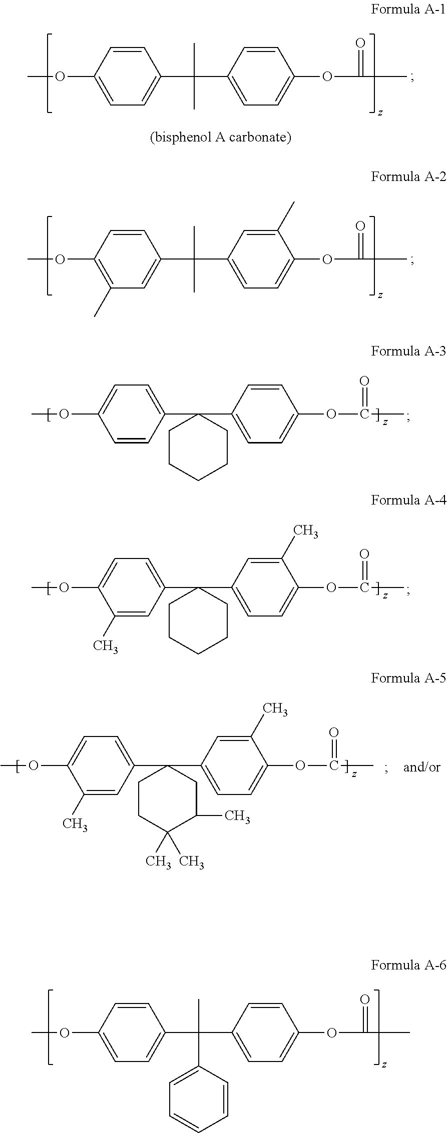

In a fourth embodiment, the film forming copolymer used for overcoat preparation is yet another variant derived by modifying or replacing the phthalic acid segmental block (B) of the A-B diblock copolymer of Formulas (I) and (II) by an alternate organic acid. Therefore, the acid terminal segmental block (B) in the copolymer variants have one of the following structures:

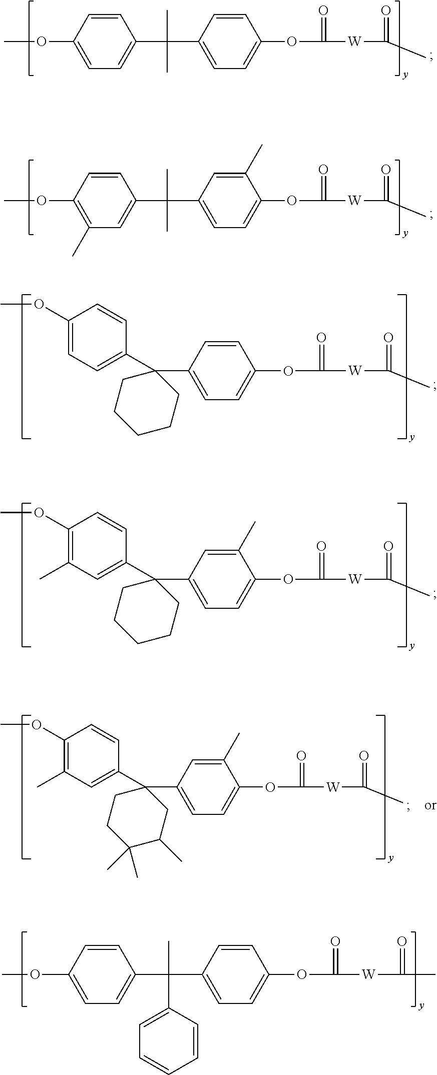

wherein the W in the segment block (B) is an aromatic moiety or an aliphatic moiety of dicarboxylic acid derived from such as a phthalic acid, an terephthalic acid, an isophthalic acid, or derived from an aliphatic acid such as an glutaric acid, adipic acid, heptanedioic acid, octanedioic acid, azelaic acid, decanedioic acid, and the like as shown belowderived from an aliphatic acid such as an glutaric acid, adipic acid, heptanedioic acid, octanedioic acid, azelaic acid, decanedioic acid, and the like as listed below:

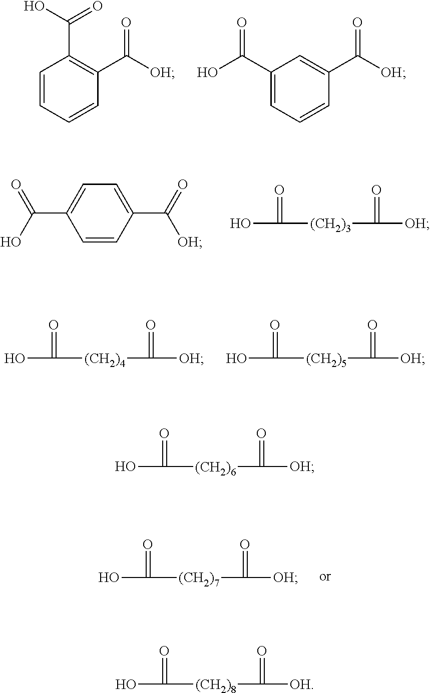

In the above embodiments, y is from about 1 to about 2.

In a fifth embodiment, the film forming copolymer used for over coat preparation is yet another extended variant derived by modification or replacement of both segmental block (A) and block (B) of the A-B diblock copolymer of Formulas (I) and (II). Therefore, the resulting A-B diblock copolymers comprise of the combinations of all the preceding alternate polycarbonate block (A) and alternate organic acids block (B) in its copolymer back bone.

In a sixth embodiment, the overcoated seamed intermediate transfer belts prepared according to the descriptions of all the above embodiments of this disclosure also include electrical conductive particles dispersion 34 in each overcoat material matrix, such as for example: titanium dioxides, polyaniline, carbon black, or the like to render desirable electrical conductivity. However, carbon black dispersion is generally preferred for its low cost and ease of dispersion. In the same manner, conductive particles dispersion 34 of titanium dioxides, polyaniline, carbon black, or the like dispersion is also incorporated into the seamed intermediate transfer belt 16 to give electrical conductivity as well. Even though the conductive particles selected for dispersion may be identical one in both the overcoat 30 and the seamed intermediate transfer belt 16, nonetheless it may also be of different particles.

The amount of conductive particles dispersion present in either the overcoat or the seamed intermediate transfer belt may be of the same or different in concentration; but good conductivity matching between these two layers is preferred to achieve proper function for effecting toner image transfer efficiency. Typically, conductive particles dispersion is in an amount of from about 5.0 to about 15.0 percent (corresponds to about 95 and about 85 percent of the polymer binder in the respective layer) or from about 9.0 to about 12.0 percent (corresponds to about 91 and about 88 percent of the polymer binder in the respective layer) by weight based on the total weight of the resulting layer. In the preferred embodiments, the carbon black dispersion is included into the overcoat 30, which is carried out by adding a pre-determined amount of carbon black particles into, with agitation, a solution prepared by dissolving the A-B diblock copolymer in a preferred organic solvent, then solution coating it over the circumferential top surface of a seamed intermediate transfer belt, and followed by subsequently drying at elevate temperature to give a flexible overcoated seamed intermediate transfer belt of this disclosure. The resulting overcoat 30, as obtained according to this disclosure, has a resistivity of between 1.0×10⁹ ohms/sq. and 1.0×10¹³ ohms/sq.; or between 1.0×10¹⁰ ohms/sq. and 1.0×10¹² ohms/sq.; or 1.0×10¹¹ ohms/sq. and 5.0×10¹¹ ohms/sq. In these embodiments, the overcoat 30 prepared according to the material formulation and process of this disclosure has a thickness of from about 2 to about 20 microns for a seamed intermediate transfer belt having a thickness of between about 50 microns and about 100 micron. Therefore, the overcoat 30 applied onto the seamed intermediate transfer belt 16 has a thickness ratio of from about 0.02 to about 0.4.

The overcoated seamed intermediate transfer belt may be formed in a number of ways. In such embodiments, a prepared prior art intermediate transfer web stock is cut to give rectangular sheets of a specified length. For each cutting sheet, the two opposite ends of the sheet are joined by any conventionally known method. For example, the two opposite ends of the cut sheet may be bonded by butt-joints through soluble solvent fusion to give an intermediate belt. Since the conventional intermediate transfer material is not readily soluble in common organic solvent for effecting solvent fusion seam joining, the intermediate transfer belt is usually form by ultrasonically welding the opposite overplay ends of the cut sheet to give a seamed intermediate transfer belt 16 readily for overcoat application. The preparation of overcoat 30 of this disclosure was carried out by first dissolving the A-B diblock copolymer in a preferred organic solvent to formed a coating solution, then solution applied over the outer circumferential surface of the flexible seamed intermediate transfer belt 16, and followed by drying at an elevated temperature of at least 10° C. higher than the boiling point of the solvent used for the coating solution preparation to give a resulting dried overcoating layer 30 over the seamed intermediate transfer belt 16. However, it is preferably that the overcoat 30 is incorporated with carbon black particles dispersion to render desirable electrical conductivity.

Various exemplary embodiments encompassed herein include a method of imaging which includes generating an electrostatic latent image on an imaging member, developing a latent image, and transferring the developed electrostatic image to a suitable substrate.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below and is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

### Example 1

Preparation of Seamed Intermediate Transfer Belt

A flexible seamed polyimide belt of prior art was prepared, using a rectangular cut sheet of a polyaniline particles dispersed 3-mil thick KAPTON® KJ, a thermoplastic polyimide having a thermal contraction coefficient of 6.2×10⁻⁵/° C., a Glass Transition Temperature (Tg) of 210° C. (available from E.I. Du Pont de Numours and Company), by overlapping the 2 opposite ends and ultrasonically welded, using 40 KHz frequency, into a seamed flexible polyimide intermediate transfer belt. Since the resulting welded seam had about ½ micron projecting height in the seam area than that of the bulk of the belt which was 75 microns in thickness, the seam is not a functionally imageable area.

### Example 2

Overcoat Solution Preparation

Master Solution

A 17.5% wt LEXAN HLX solution was prepared by first mixing the precise amount of LEXAN HLX copolymer in DMF. The mixture was rolled-mill overnight (or at least 12 hours) and then submersed in 85° C. hot water bath to totally dissolve the copolymer and gave a master solution. LEXAN HLX, available for Sabic Innovative plastic, is a high Mw A-B diblock copolymer of about 175,000 as shown in Formulas (I) and (II) below:

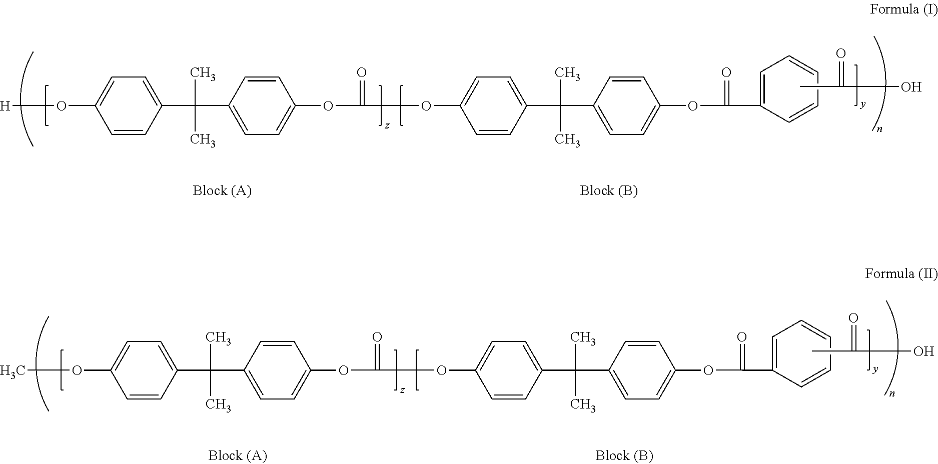

wherein z represents the number of bisphenol A repeating units in block A of from about 9 to about 18, y is number of repeating phthalic acid block B of from about 1 to about 2, and n is the degree of polymerization between about 20 and about 90 for the copolymer having a weight average molecular weight between about 100,000 and about 250,000, or from about 40 to about 70, in which the copolymer may have a weight average molecular weight between about 130,000 and about 200,000, and mixtures thereof.

Mill Base Solution

A 12% wt LEXAN HLX solution was likewise prepared by first mixing the precise amount of LEXAN HLX copolymer in DMF, rolled-mill overnight to dissolve the copolymer. A predetermined amount of carbon black (Special Black 4 from Evonik Industries) was then added into the solution and attritor milled with 1 mm diameter stainless steel beads for 6 hours to give a 10% wt carbon black dispersion mill-base solution. The final dispersion mill-base solution has a 22% wt solid content.

Overcoating Solution

The prepared 22% wt mill-base solution was then mixed with the 17.5% wt LEXAN HLX master solution as 1 part (22% wt mill-base) with 4 parts (17.5% wt Lexan HLX master solution) and plus the addition of small amount of fluoro compound surface leveling agent (Novec FC4432 from 3M Corporation) at 0.01% wt. The mixture was again rolled-mill overnight (or at least 12 hours) to give a final overcoating solution.

The final overcoating solution (having 15.4% wt HLX copolymer, 2.2% wt carbon black, and 0.01% wt FC4432) was then applied directly over the top circumferential surface of the seamed intermediate transfer belt prepared according to Example 1 above and subsequently dried at 140° C. for 1.3 hours to give a 10-micron thick dried overcoat layer of the present disclosure. The overcoat layer, as obtained, gave an uniform surface coverage over the circumferential surface of the seamed intermediate belt to thereby eliminate seam area projecting height and an electrical conductivity of about 1.08×10¹¹ ohms/sq. equivalent to that of the seamed intermediate transfer belt; in addition, the overcoat layer was also found to be bonded so strongly onto the surface of the belt not able to be peeled off. Therefore, the resulting overcoated seamed intermediate transfer belt as prepared, consisting of an overcoat 30 over a seamed intermediate transfer belt 16, was in the same configuration as that illustrated in FIG. 3.

The overcoat layer of this disclosure could also be conveniently prepared to give any suitable thickness, from 2 to 20 microns in thickness, to meet any specific intermediate transfer belt's requirement.

In summary, the present embodiments describe an overcoated seamed intermediate transfer belt that exhibited desirable electrical conductivity and mechanical property, including increased wear resistance, and methods for making the same. And very importantly, provides entire circumferential belt surface imageability which thereby eliminates the problem associated with the impact from seam height and material discontinuity. The novel overcoat formulation was comprised of a film forming A-B diblock copolymer to provide superior mechanical function; and in embodiments, carbon black dispersion was included to render desirable electrical conductivity.

All the patents and applications referred to herein are hereby specifically, and totally incorporated herein by reference in their entirety in the instant specification.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An overcoated seamed intermediate transfer belt comprising:
a seamed intermediate transfer belt; and
an overcoat layer comprising a polycarbonate disposed on the seamed intermediate transfer belt, wherein the polycarbonate is an A-B diblock copolymer comprising a bisphenol A polycarbonate segmental block (A) and a phthalic acid containing segmental block (B) terminal selected from the group consisting of Formula (I) and Formula (II) below: 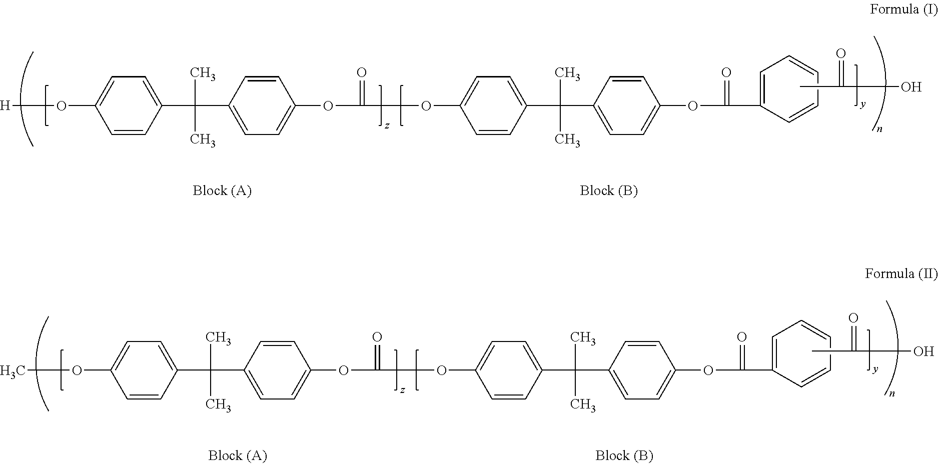
wherein z represents the number of bisphenol A repeating units in segmental block (A) of from about 9 to about 18, y is number of repeating phthalic acid segmental block (B) of from about 1 to about 2, and n is the degree of polymerization between about 20 and about 90 for the copolymer having a weight average molecular weight between about 100,000 and about 250,000 and mixtures thereof.

2. The image forming apparatus of claim 1, wherein the overcoat layer further comprises carbon black particle dispersion.

3. The image forming apparatus of claim 2, wherein the overcoat layer has an electrical resistivity of between 1.0×10⁹ ohms/sq. and 1.0×10¹³ ohms/sq.

4. The image forming apparatus of claim 1, wherein the degree of polymerization n of the A-B diblock copolymer in the overcoat layer is from about 40 to about 70.

5. The image forming apparatus of claim 4, wherein the weight average molecular weight of the A-B diblock copolymer is from about 130,000 to about 200,000.

6. The image forming apparatus of claim 1, wherein the bisphenol A segmental block (A) of the A-B diblock copolymer of Formulas (I) and (II) is replaced by another polycarbonate selected from the group consisting of:

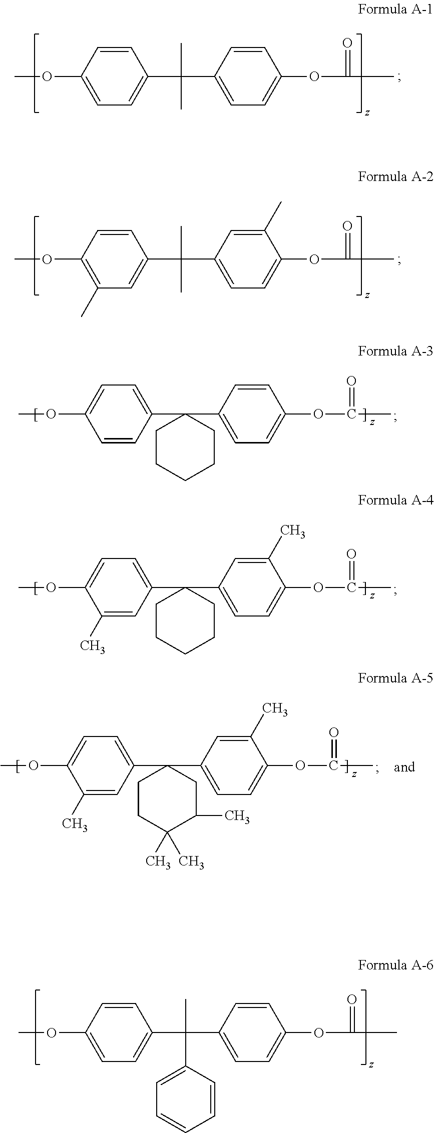

7. The image forming apparatus of claim 1, wherein the phthalic acid segmental block (B) of the A-B diblock copolymer of Formulas (I) and (II) is replaced by another organic acid selected from the group consisting of: 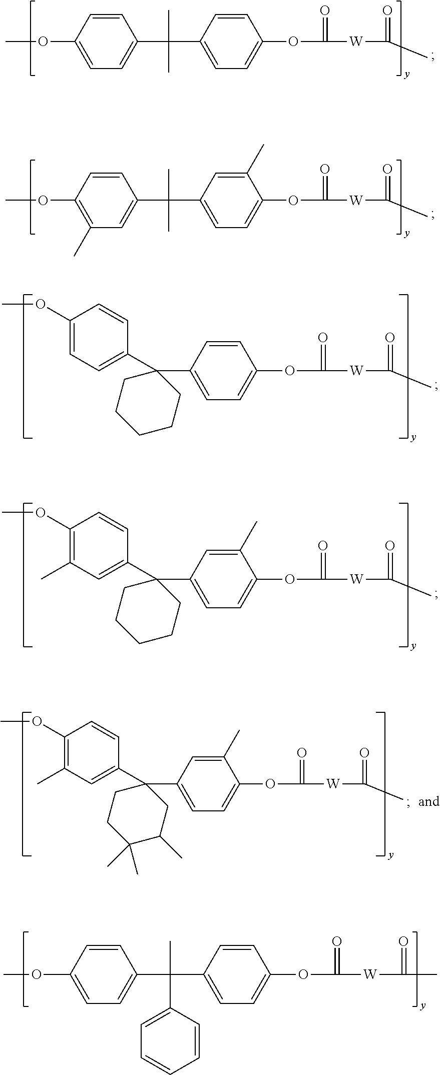
wherein W is an aromatic moiety or an aliphatic moiety of dicarboxylic acid derived from a phthalic acid, an terephthalic acid, or an isophthalic acid, or an aliphatic acid, and y is from about 1 to about 2.

8. The image forming apparatus of claim 1, wherein the overcoat layer has a thickness of from about 5 to about 20 microns.

9. The image forming apparatus of claim 1, wherein the seamed intermediate transfer belt in the overcoated seamed intermediate transfer belt has a thickness of from about 50 to about 100 microns.

10. An image forming apparatus comprising:
an imaging member for forming a toner image; and
an overcoated seamed intermediate transfer belt for transferring the toner image formed on the imaging member to a receiving medium, the overcoated seamed intermediate transfer belt comprising
a seamed intermediate transfer belt, and
an overcoat layer comprising a polycarbonate disposed on the seamed intermediate transfer belt, wherein the overcoat layer comprises a dispersion of carbon black particles in an A-B diblock copolymer comprising a bisphenol A polycarbonate segmental block (A) and a phthalic acid containing segmental block (B) terminal selected from the group consisting of Formula (I) and Formula (II) below: 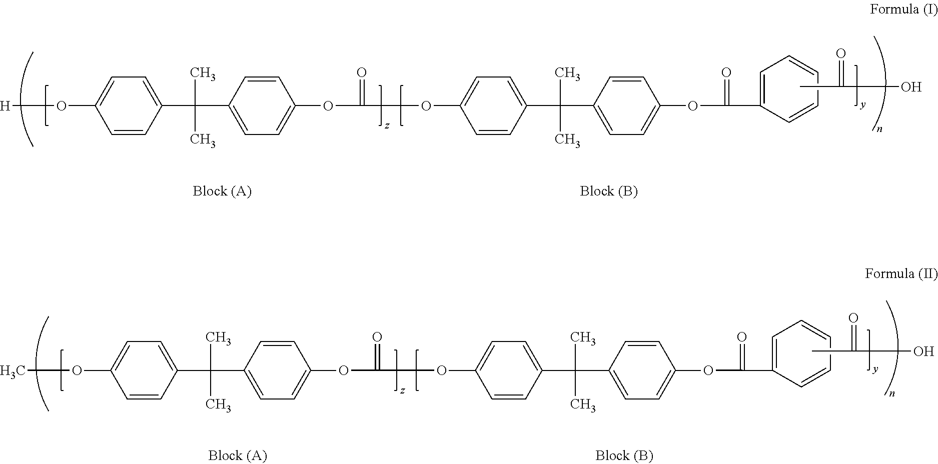
wherein z represents the number of bisphenol A repeating units in segmental block (A) of from about 9 to about 18, y is number of repeating phthalic acid segmental block (B) of from about 1 to about 2, and n is the degree of polymerization between about 20 and about 90 for the copolymer having a weight average molecular weight between about 100,000 and about 250,000 and mixtures thereof.

11. The image forming apparatus of claim 10, wherein the carbon black particle dispersion in the overcoat layer is in an amount of from about 5.0 to about 15.0 percent by weight of the total weight of the overcoat layer.

12. The image forming apparatus of claim 11, wherein the carbon black particle dispersion in the overcoat layer is in an amount of from about 9 to about 12 percent by weight of the total weight of the overcoat layer.

13. The image forming apparatus of claim 10, wherein the polycarbonate in the overcoat layer is in an amount of from about 95 to about 85 percent by weight of the total weight of the overcoat layer.

14. The image forming apparatus of claim 13, wherein the polycarbonate in the overcoat layer is in an amount of from about 91 to about 88 percent by weight of the total weight of the overcoat layer.

15. The image forming apparatus of claim 14, wherein the overcoat layer has an electrical resistivity of between 1.0×10⁹ ohms/sq. and 1.0×10¹³ ohms/sq.

16. An image forming apparatus comprising:
an imaging member for forming a toner image; and
an overcoated seamed intermediate transfer belt for transferring the toner image formed on the imaging member to a receiving medium, the overcoated seamed intermediate transfer belt comprising
a seamed intermediate transfer belt, and
an overcoat layer comprising a polycarbonate disposed on the seamed intermediate transfer belt, wherein the polycarbonate is an A-B diblock copolymer comprising a bisphenol A polycarbonate segment block (A) and a phthalic acid containing segment block (B) terminal selected from the group consisting of Formula (I) and Formula (II) below: 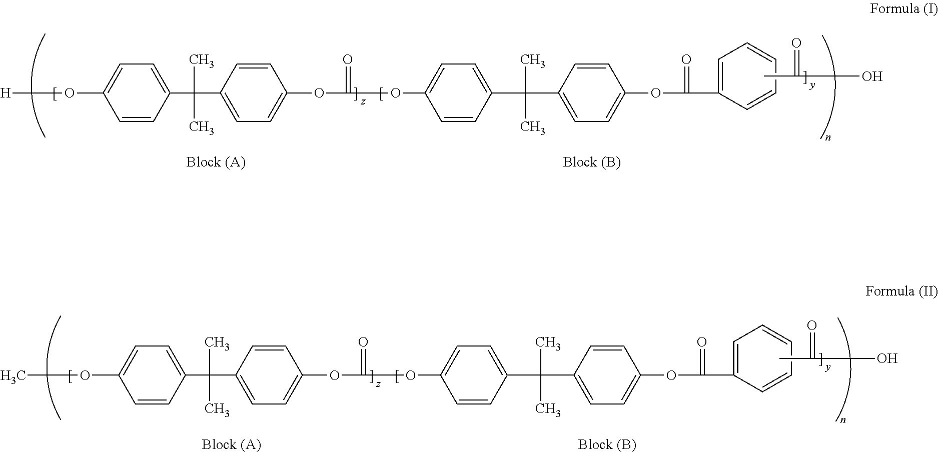
wherein z represents the number of bisphenol A repeating units in segmental block (A) of from about 9 to about 18, y is number of repeating phthalic acid segmental block (B) of from about 1 to about 2, and n is the degree of polymerization between about 20 and about 90 for the copolymer having a weight average molecular weight between about 100,000 and about 250,000 and mixtures thereof.

17. The image forming apparatus of claim 16, wherein the overcoated intermediate transfer belt is prepared by applying an coating solution of A-B diblock copolymer directly over the top circumferential surface of the seamed intermediate transfer belt and dried at an elevated temperature of at least 10° C. higher than a boiling point of a solvent used in the overcoating solution.

18. The image forming apparatus of claim 16, wherein the seamed intermediate transfer belt is prepared by cutting an intermediate transfer web into a rectangular sheet, overlapping the two opposite ends of the sheet, and ultrasonically welding the sheet into a seamed intermediate belt.

19. The image forming apparatus of claim 16, wherein the overcoat layer further includes carbon black particle dispersion in an amount of from about 5 to about 15 percent by weight of the total weight of the overcoat layer.

20. The image forming apparatus of claim 16, wherein the A-B diblock copolymer is present in an amount of from about 95 to about 85 percent by weight of the total weight of the overcoat layer.
